(19) United States
(12) Patent Application Publication
(10) Pub. No.: US 2011/0004650 A1
(43) Pub. Date: Jan. 6, 2011

(54) METHOD AND AGENT FOR PROCESSING MESSAGES EXCHANGED BETWEEN TERMINALS

(76) Inventors: Fabrice Poussiere, Nozay (FR); Ronan Daniellou, Nozay (FR)

Correspondence Address: FAY SHARPE/LUCENT, 1228 Euclid Avenue, 5th Floor, The Halle Building, Cleveland, OH, 44115-1843, US

(21) Appl. No.: 12/808,900

(22) PCT Filed: Dec. 18, 2008
(86) PCT No.: PCT/FR08/52361

§ 371 Date: Sep. 7, 2010

(30) Foreign Application Priority Data
Dec. 20, 2007 (FR) 0708949

(51) Int. Cl. G06F 15/16

(52) U.S. Cl. 709/202

(57) ABSTRACT

A method for processing messages exchanged between terminals, which method comprises the steps consisting of:
logging the exchanged messages;
filtering the contextual data of the logged messages based on predefined criteria, in order to form contextualized logged data;
applying at least one relevance rule to the contextualized logged data, in order to produce relevant data;
addressing the relevant data as input to a web content management agent, particularly such as a wiki.

The invention pertains to the technical field of the collaborative creation of data with the assistance of telecommunications networks.

In blogs (short for weblogs, a portmanteau word derived from the contraction of web and log), data, potentially multimedia, is shared, and visitors may leave tracks. Blogs are websites for free and regular expression in the form of texts, hypertext links and/or images published over time in reverse chronological order, often by a single author and on a personal basis. Blogs enjoy a lively success, to the extent that several search engines are devoted to them, such as Technorati, Feedster, or Sphere. It is estimated that the number of blogs doubles every six months, and that there are several tens of millions of them. A blog generally contains the following elements: messages (posts) ranked in reverse chronological order); the blog's archives (viewable by date); the list of external links (blogroll), this list formalizing the mutual recognition by the authors of their belonging to a single virtual community; the RSS (Rich Site Summary, Really Simple Syndication) feed providing a description, structured by tags, of a blog's various elements: message titles, content, date, author, links.

Blogs have several disadvantages. They can in principle be visited by any Internet user, and generally do not enable the creation of closed or conditional access virtual communities. Bloggers can assume false identities, and different nicknames are a frequent occurrence. Bloggers are not visible or face to face with their public. Furthermore, the great majority of blogs do not enable real time interactions. Moreover, on blogs, multimedia documents are not properly protected against illegal copying.

For all these reasons, blogs are not suitable tools for real-time communication, in particular business data communication between members of a workgroup. Nor are blogs a good medium for the collaborative creation of documents. The most common use of a blog is as an online diary or travelogue. Also familiar are opinion blogs, kept by professional journalists or politicians, as well as company blogs. Visitors cannot claim to influence the blog content, which is not, should be speaking, the product of collaborative work.

Internet videoconferencing systems are known (for example WebeX Meeting Center, Microsoft Live Meeting, Citrix GoTo Meeting, Groove Virtual Office, eZmeeting). These systems have many applications, such as remote engineering, distance learning (or e-learning), and work meetings. Videoconferencing is an audiovisual teleconference service providing a real time bi-directional transfer of voice and animated color images as well as computer data between user groups located in at least two different places, in either point-to-point or multipoint mode. The VRVS (Virtual Room Videoconferencing System) enables e.g. reservation of virtual conference rooms on the Mbone or in the H323 protocol. An H323 terminal is equipped with software such as e.g. Netmeeting by Microsoft or Ekiga.

Videoconferencing systems have certain disadvantages. In particular, multimedia documents can only be viewed within a session, and the session must be open before the publication of multimedia documents. The minutes of meetings held by videoconferencing are prepared in the same way for every conference, by summarizing handwritten notes.

Instant messaging software is also known. The Microsoft Windows Live Spaces platform couples the old functionalities of the old MSN Spaces platform with the MSN Messenger instant messaging software, with a Friends Explorer module enabling users to invite their friends to contact the friends of their own contacts. Windows Live Spaces enables the creation of personal spaces and conditional access communities:

Instant messaging software is suitable for interpersonal exchanges, on a conversational level, particularly friendly conversation (chatting). It is not geared towards collaboratively writing documents.

Furthermore, website content management systems are known, the content of these websites being established by authorized visitors. These systems are known as Wikis. One presentation of these systems may be found on a Wiki known as Wikipedia http://en.wikipedia.org. In principle, within a wiki, all authorized people may edit the content, with the same editing rights. However, the templates, general browsing information serving as a template for the page's structure, cannot be edited.

Wikis exhibit several drawbacks, making their usage tricky under certain circumstances. In particular, whenever changes to data are not justified by identified references, the wiki may contain biased or incorrect elements. This risk is even higher if the contributors are not identifiable (such as because only an IP address is required to become a contributor). Furthermore, it is currently difficult to extract from wikis information contained within different articles, wikis not currently being equipped with semantics (see Krötzsch et al Semantic Wikipedia, Web Semantics Science Services and Agents on the World Wide Web, 5, 2007, pp. 251-261).

The development of Web 2.0 includes the transformation of content management tools, particularly including wikis.

The invention aims to provide new content management tools, suitable for the needs of service companies and industries.

More particularly, the invention aims to provide collaborative data creation tools which do not exhibit the drawbacks of known tools.

The invention finds a particularly advantageous application in creating meeting minutes and in establishing summary notes as part of a knowledge management approach. The term knowledge management here refers to all technological and methodological tools intended to share, structure, enhance, and make accessible the information in a consistent and useful form for a group of people, for example a business. The importance of knowledge management has increased over the past few years, by the combined effect of the emergence of a knowledge economy and the pyramid shape of age groups in industrialized countries.

For these purposes, the invention pertains, according to a first aspect, to a method for processing messages exchanged between terminals, which method comprises the steps consisting of:
logging the exchanged messages;
filtering the contextual data of the logged messages based on predefined criteria, in order to form contextualized logged data;
applying at least one relevance rule to the contextualized logged data, in order to produce relevant data;
addressing the relevant data as input to a web content management agent, particularly such as a wiki.

“Logging” here refers to storing data for long-term use. The “logged” data is no longer unstable, and is entered into the log, for example the company's log. The logging of data is a technique well known in and of itself for databases (datawarehousing).

The term “contextual data” here refers to information regarding three aspects of a message: the message's content, the messenger's identity, and the conditions under which the message was created and transmitted. Contextual data includes information such as the time sent, the messenger's name, and the meeting room's name.

The term “relevance rule” here refers to a rule regarding the content of the message, the messenger's identity, or the conditions under which the message was created and transmitted. For example, Bob is a recognized expert in a given professional field. In such a case, one relevance rule would be “messages sent by Bob for this professional field”. Also in this example, quality of service (QoS) is a field of activity of both Alice and Bob. In such a case, one relevance rule would be “messages sent by Alice or Bob, in which the term QoS or the expression quality of service is present”.

The term “web content management agent” here particularly refers to wiki software.

Advantageously, the messages are exchanged using the SIP protocol (Session Initiation Protocol). A description of the SIP particle is provided in Chapter XII of the work “IMS IP Multimedia Concepts and Services”, 2006, ISBN-13: 978-0-470-01906-1. One may also refer to the IETF standard RFC 3261 from June 2002. The SIP protocol provides functions for establishing, modifying, and terminating communication sessions, and particularly handles authentication. The SIP protocol is used in the IMS (IP Multimedia Subsystem) architecture, enabling users of fixed or mobile terminals to exchange videos while continuing their conversation. The documents US 2002/0196775 and US 2006/0104306 illustrate applications of the IMS architecture.

SIP is a request/response protocol. For each message sent by a source, there is at least one response associated with the recipient confirming the receipt of the sent message: the SIP requests are acknowledged by responses identified by a numeric code, most of the SIP response codes having been borrowed from the HTTP protocol. For example, whenever the recipient is not located, a “404 Not Found” code is returned.

Advantageously, the relevant data is addressed to the Web content management agent by an HTTP request.

The invention, according to a second aspect, pertains to an agent for processing messages exchanged between terminals, which agent comprises:
a module for logging the exchanged messages;
a module for identifying contextual data of the logged messages, in order to form contextualized logged data;
a module for selecting, from among the contextualized logged data, that which satisfies at least one relevance rule, in order to produce relevant data;
a module for addressing relevant data as the input of a Web content management agent, particularly such as a wiki.

Advantageously, the agent for processing messages comprises a notification module, for sending Web content update notifications. Thus, people who have exchanged messages that served to update web content are notified of this update.

Advantageously, the message processing agent comprises a publication module, for sending requests to the web interface of the Web content management agent. This publication module sends the relevant data to the Web content management agent, in a format suitable for that management agent.

Other objects and advantages of the invention will become apparent upon reading the following description of currently preferred embodiments, which will be carried out referring to the attached drawings, in which:

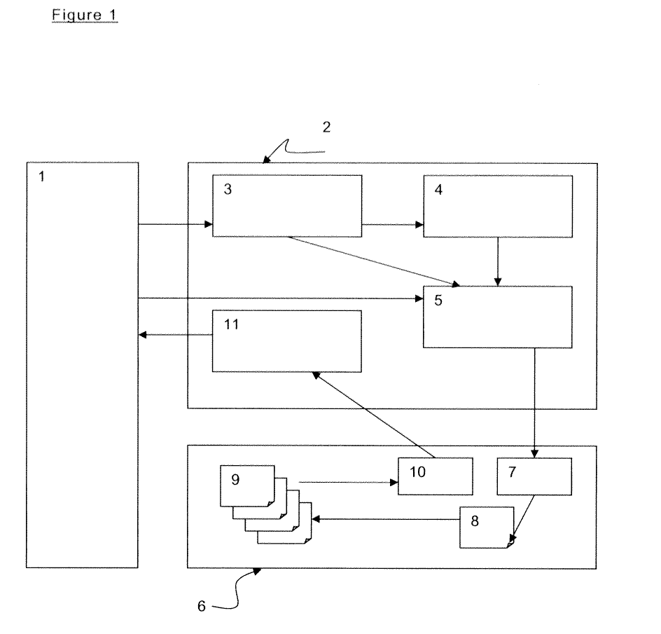

FIG. 1 is a schematic diagram illustrating the functional architecture of an assembly comprising means according to the invention;

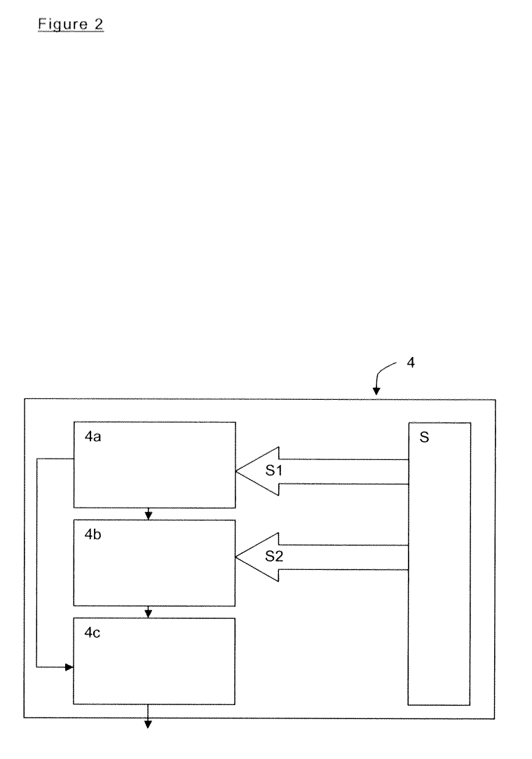

FIG. 2 is a detailed diagram of one of the modules depicted in FIG. 1.

In the remainder of this description, for simplicity's sake, messages are assumed to have an exchange between clients of a messaging service, in particular instant messaging, and the content of the messages is stored in an application server, which is not depicted.

The following description will be carried out with reference to an instant messaging communications session, implementing the SIP protocol, such as an IMS architecture.

A communication session implemented with the assistance of the SIP protocol requires creating a meeting room for an instant messaging client (hence a first SIP message).

The messaging application server publishes this room creation (hence a second SIP message, sent to each of the participants' terminals).

Next, the participants may join the room (hence a third SIP message, coming from each of the participants' terminals).

During the meeting, the participants exchange their messages, using the SIP protocol.

The session is closed when the last participant leaves the meeting room.

The processing agent 2 may be a module of the instant messaging application server, or form an application interfaced with that messaging server.

The processing agent 2 includes:
a logging module 3;
an analysis module 4;
a publication module 5.

The logging module 3 ensures the storage of exchanged messages for their long-term use. This long-term use includes the possibility for users 1 of reading all exchanged messages and selecting them, as will become more fully apparent later on.

The logging module 3 sends all the new messages to the analysis module 4. The logging module also 3 sends all the data portions selected by the user 1 to the publication module 5.

The analysis module 4 includes multiple functions assisting the user in automatically identifying the relevant data contained within the exchanged SIP messages, these messages being of two types:
the communication session opening and closing SIP messages (session signaling);
SIP communication messages between the participants, throughout the communication session.

The analysis module 4 comprises three submodules 4a, 4b and 4c.

The first submodule 4a identifies the elementary information contained within the SIP session signaling messages, for example the time, user's name, and type of message (invite, bye, meeting room creation, meeting room name).

The second submodule 4b identifies the elementary information contained within the SIP communication messages, for example: participant's name, time sent.

The third submodule 4c builds information, based on the elementary information obtained by the two submodules 4a and 4b, and rules.

The two tables below depict some elementary information that may be identified by submodules 4a and 4b, as well the sources of this information within the SIP messages.

| | SIP session signaling |
|---|---|
| Information | message |
| Start of meeting | “Register” message from the |
| | first participant |
| | “Invite” message from the last |
| | participant |
| End of meeting | “Unregister” message from the |
| | first participant |
| | End message from the last |
| | participant |
| Meeting duration | Difference between the |
| | “Register” message from the |
| | first participant and the last |
| | “Unregister” message |
| Name of he meeting's | “Create meeting room” SIP |
| host | message |
| Name and subject of the | “Create meeting room” SIP |
| meeting | message |
| Relevant instant | “Create meeting room” SIP |
| messages, using | message |
| keywords employed in | |
| the meeting's name | |

| | SIP messages of exchanges |
|---|---|
| Information | between participants |
| Relevant instant | All participants' messages |
| messages, using | |
| keywords employed in | |
| the meeting's name | |
| Participation rate | Statistical analysis, based on |
| | messages exchanged between |
| | the participants. |
| Participants most | Participants who asked the |
| interested by the subject | most questions |
| of the meeting | |
| Name of the expert | Detection of messages sent in |
| during the meeting | response to a question |

Other types of information may be extracted, for example:
selecting all phrases including the “to do” tag or detecting all phrases including the verb “plan”
selecting all messages coming from a user identified as an expert;
selecting all messages which include both a question and answer;
selecting all messages containing the keywords related to the subject of the meeting.

The analysis module 4 transmits to the publication module 5 all of the selected data.

This publication module 5 sends a publication request to the web interface 7 of a Web content management agent 6. Advantageously, this request is carried out using the HTTP protocol.

The Web content management agent 6 ensures the creation of a new document 8, based on data transmitted by the publication module 5. In other words, the Web content management agent 6 formats the data transmitted by the publication module 5.

This new document 8 is then incorporated into the Web content 9, for example a wiki.

A Web document update or creation notification is sent by a notification module 10 to the management agent 6. More precisely, this notification is sent to a module 11 of the agent 6.

The user 1 is thereby directly informed of the creation of the Web document, or the updating of that Web document.

The description made with reference to an instant messaging communication session is not exclusive. The messages handled by the agent 6 may come from other origins, for example push to talk, chat.

The logging module 3 of the agent 6 may be incorporated into a messaging application server, the exchanged messages being in a situation transmitted to the analysis module 4.

The notifications of the Web content management agent 6 may be transmitted to the user by a web interface, or by means of a plug in.

Advantageously, the rights of the participants in the meeting are transmitted to the Web content, for example a wiki. For example, the meeting's manager is an administrator for the wiki, with the participants able to read the Web content 9 but not edit it.

1. A method for processing messages exchanged between terminals, which method comprises the steps consisting of:
logging the exchanged messages;
filtering the contextual data of the logged messages based on predefined criteria, in order to form contextualized logged data;
applying at least one relevance rule to the contextualized logged data, in order to produce relevant data;
addressing the relevant data as input to a web content management agent, particularly such as a wiki.

2. A method according to claim 1, characterized in that the messages are exchanged by the SIP (Session Initiation Protocol) protocol.

3. A method according to claim 1, characterized in that the relevant data is addressed to the Web content management agent by an HTTP request.

4. An agent for processing messages exchanged between terminals, this agent comprising:
a module for logging (3) the exchanged messages;
a module (4a, 4b) for identifying contextual data from the logged messages, in order to form contextualized logged data;
a module (4c) for selecting, from among the contextualized logged data, that which satisfies at least one relevance rule, in order to produce relevant data;
a module for addressing relevant data as the input of a Web content management agent (6), particularly such as a wiki.

5. An agent according to claim 4, characterized in that it comprises a notification module (11), for sending Web content update notifications (9).

6. An agent according to claim 4, characterized in that it comprises a publication module (5), for sending requests to the web interface (7) of the web content management agent (6).
